(19) United States
(12) Patent Application Publication
(10) Pub. No.: US 2018/0246763 A1
(43) Pub. Date: Aug. 30, 2018

(54) COMPUTER SYSTEM MANAGEMENT METHOD AND COMPUTER SYSTEM

(71) Applicant: HITACHI, LTD., Tokyo (JP)

(72) Inventors: Yuta ENO, Tokyo (JP); Akira NISHIMOTO, Tokyo (JP); Toshio OTANI, Tokyo (JP)

(73) Assignee: HITACHI, LTD., Tokyo (JP)

(21) Appl. No.: 15/754,478

(22) PCT Filed: Sep. 25, 2015
(86) PCT No.: PCT/JP2015/077140

§ 371 Date: Feb. 22, 2018

(51) Int. Cl. G06F 9/50; G06F 9/455; G06Q 30/02

(52) U.S. Cl. CPC G06F 9/5011; G06Q 30/0283; G06F 9/45533

(57) ABSTRACT

It is provided a method of managing a computer system, the computer system being configured to provide a virtual computer used by a customer, the virtual computer being coupled to a management computer configured to manage resources to be allocated to the virtual computer, the method including steps of: monitoring, by the management computer, a usage state of the resources allocated to the virtual computer; creating, by the management computer, a new allocation plan in which an amount of resources allocated to the virtual computer is reduced based on the monitored usage state of the resources allocated to the virtual computer; and creating, by the management computer, a virtual computer migration plan including the virtual computer created by the new allocation plan based on selection of the allocation plan by the customer.

### BACKGROUND OF THE INVENTION

This invention relates to a method of managing resources.

Hitherto, in a cloud system, new resources have been required in order to allocate a virtual computer to a customer. In order to accommodate the new customer in the system, new hardware has been required to be provided in the system.

As the background art of the technology of this invention, there is WO 2014/122743 A1. In WO 2014/122743 A1, there is disclosed a management system configured to add a usage resource history of a virtual guest to be migrated to a usage resource history of each migration-destination-candidate virtual host, estimate the usage resource history of each migration-destination-candidate virtual host obtained in a case where the virtual guest to be migrated is assumed to have been moved, and determine the destination virtual host from among the migration-destination-candidate virtual hosts based on the estimation result.

### SUMMARY OF THE INVENTION

However, in WO 2014/122743 A1, there is no consideration given to changing the amount of resources to be allocated in view of the resource usage history to efficiently utilize resources that have become available due to the change in resource allocation. More specifically, in WO 2014/122743 A1, there is no consideration given to accommodating a new customer in the system based on resources that have become available due to a change in the allocation of resources for existing customers.

Efficient utilization of existing resources is important from the perspective of reducing system costs. In recent years, it is desired that data centers reduce power usage, and hence the efficient utilization of existing resources is also important from the perspective of reducing power consumption.

The representative one of inventions disclosed in this application is outlined as follows. There is provided a method of managing a computer system, the computer system being configured to provide a virtual computer used by a customer, the virtual computer being coupled to a management computer configured to manage resources to be allocated to the virtual computer, the method including steps of: monitoring, by the management computer, a usage state of the resources allocated to the virtual computer; creating, by the management computer, a new allocation plan in which an amount of resources allocated to the virtual computer is reduced based on the monitored usage state of the resources allocated to the virtual computer; and creating, by the management computer, a virtual computer migration plan including the virtual computer created by the new allocation plan based on selection of the allocation plan by the customer.

According to the an aspect of this invention, a new virtual machine can be allocated without increasing resources. Problems, configurations, and effects other than those described above are made clear based on the following description of an embodiment of this invention.

### BRIEF DESCRIPTION OF THE DRAWINGS

FIG. 1 is a diagram for illustrating a configuration of a resource management system of an embodiment of this invention.

FIG. 2 is a diagram for illustrating a logical configuration of the management computer of the embodiment of this invention.

FIG. 3 is a diagram for showing a structural example of the customer info′ illation table of the embodiment of this invention.

FIG. 4 is a diagram for showing the virtual machine allocation plan table 115 of the embodiment of this invention.

FIG. 5 is a diagram for showing the resource management table of the embodiment of this invention.

FIG. 6 is a diagram for showing the variable fee program usage group management table of the embodiment of this invention.

FIG. 7 is a flowchart of resource usage state collection processing of the embodiment of this invention.

FIG. 8 is a flowchart of resource aggregation allocation processing of the embodiment of this invention.

FIG. 9A is a diagram for illustrating a configuration example of the plan proposal screen to the customers of the embodiment of this invention.

FIG. 9B is a diagram for illustrating a configuration example of a group selection screen of the embodiment of this invention.

FIG. 9C is a diagram for illustrating a configuration example of the plan details screen for the customers of the embodiment of this invention.

FIG. 10 is a flowchart of aggregation execution processing of the embodiment of this invention.

### DETAILED DESCRIPTION OF THE PREFERRED EMBODIMENTS

In the following description, although pieces of information of this invention are described by using such expressions as “aaa table”, “aaa list”, “aaa DB”, and “aaa queue”, those pieces of information may be expressed by data structures other than a table, a list, a DB, a queue, and the like. Therefore, “aaa table”, “aaa list”, “aaa DB”, “aaa queue”, and the like are sometimes referred to as “aaa information” in order to show that those pieces of information are independent of their data structures.

In addition, although such expressions as “identification information”, “identifier”, “name”, “ID” are used in order to describe details of each piece of information, those expressions are interchangeable.

In the following description, although a description is given by using “program” as a subject in some cases, the program is executed by a processor to perform defined processing while using a memory and a communication port (communication control device). Therefore, the description given by using “program” as a subject may also be interpreted as a description given by using “processor” as a subject. Further, processing disclosed while a program is used as a subject may also be interpreted as processing performed by a computer, for example, a management server, or an information processing apparatus. Further, a part or all of a program may also be implemented by dedicated hardware.

Further, various programs may also be installed onto each computer by a program distribution server or computer-readable storage media. The program distribution server in this case includes a CPU and storage resources, and the storage resources store a distributing program and programs to be distributed. The CPU of the program distribution server executes the distributing program, to thereby distribute to other computers the programs to be distributed.

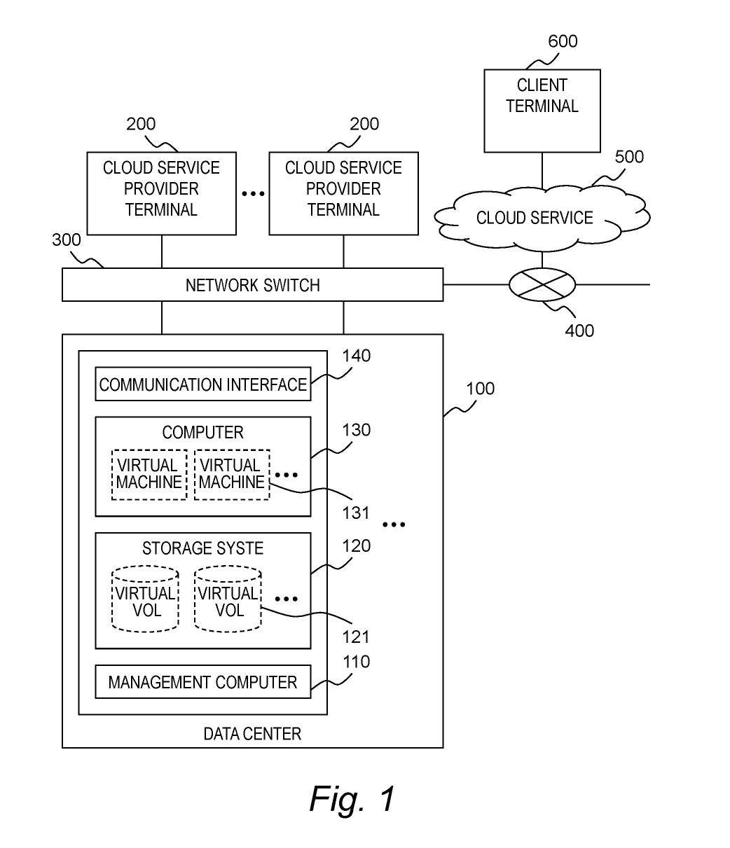

FIG. 1 is a diagram for illustrating a configuration of a resource management system of an embodiment of this invention.

The resource management system of this embodiment includes a data center 100 established by a managed service provider, cloud service provider terminals 200, and a network switch 300. The resource management system of this embodiment provides a cloud service 500 to a client terminal 600.

The data center 100 includes a management computer 110, a storage system 120, a physical computer 130, and a communication interface 140.

The storage system 120 includes a large-capacity storage device, for example, a magnetic disk drive or a solid-state drive (SSD). The storage system 120 provides logical virtual volumes 121 from a part of the storage device. The virtual volumes 121, which are provided to customers of the cloud service, store user data.

The physical computer 130 includes processor and memory resources. The physical computer 130 provides virtual machines 131 to which a part of those processor and memory resources have been allocated. The virtual machines 131, which are provided to the customers of the cloud service, execute desired calculation processing based on operations from the client terminal 600 and operations from the cloud service provider terminals 200.

The communication interface 140 is an interface for coupling resources in the data center 100 to the network switch 300. The communication interface 140 controls communication to/from the network switch 300 and the virtual machines 131 or virtual volumes 121, which are provided to the customers of the cloud service and to which a part of the resources have been allocated.

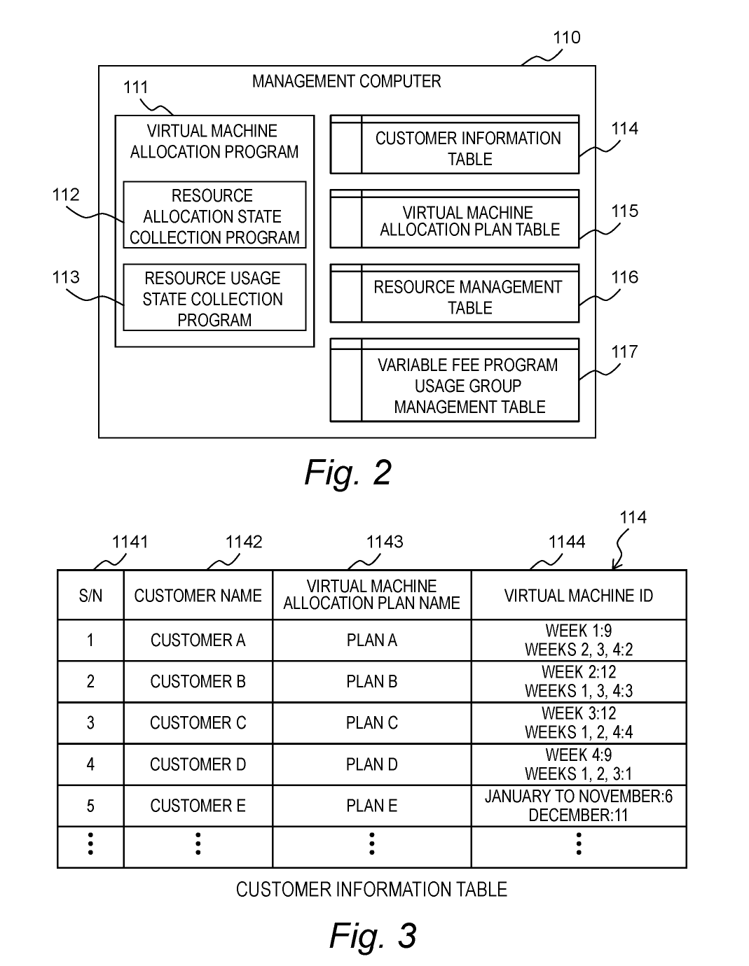

The management computer 110 is a computer for managing those resources. The management computer 110 includes a processor for executing programs and a storage device (memory and non-volatile storage device) for storing those programs. The resources of the management computer 110 may also be provided from the storage system 120 and the physical computer 130. The logical configuration of the management computer 110 is described later with reference to FIG. 2.

The management computer 110 includes an input/output device. As examples of input/output devices, a display, a keyboard, and a pointer device are conceivable, but the input/output devices may be other devices. Moreover, a serial interface or an Ethernet interface may be used as an input/output device as an alternative to the input/output devices, and input and display on the input/output devices may be substituted by coupling, to the interface, a display computer including a display, a keyboard, or a pointer device, transmitting display information to the display computer, and receiving information for input from the display computer, to thereby display information on the display computer and receive the input from the display computer.

In the following, a group of one more computers that manage an information processing system and display the display information of this invention is sometimes referred to as “management system”. In a case where the management computer 110 displays the display information, the management computer 110 is the management system. A combination of the management computer 110 and a display computer may also be the management system. In order to increase the speed and reliability of the management processing, processing identical to that of the management computer 110 may be implemented by a plurality of computers. In such a case, the plurality of computers (including a display computer in a case where the display computer displays information) are the management system.

Each of the management computer 110, the storage system 120, the physical computer 130, and the communication interface 140 may be provided in multiple.

The network switch 300 couples the data center 100, each of the cloud service provider terminals 200, and a network 400 to each other.

The cloud service provider offers a service of lending to customers resources to be provided by the managed service provider through the data center 100. Each cloud service provider terminal 200 controls the lending of resources to customers by operating the management computer 110. The management computer 110 is operated by the plurality of cloud service provider terminals 200, and the resources are provided from the data center 100.

The network switch 300 is coupled to the client terminal 600 via the network 400.

The client terminal 600 is a computer to be operated by the customer receiving the provision of resources (i.e., cloud service 500). The client terminal 600 includes a processor for executing programs, a storage device (memory and non-volatile storage device) for storing those programs, a communication interface for communication via a network, an input interface for receiving input from an operator, and an output interface for outputting an execution result of a program to the operator.

From the client terminal 600, the resources to be provided by the data center 100 appear as the cloud service 500.

In FIG. 1, one client terminal 600 is illustrated, but a plurality of client terminals 600 may be provided.

FIG. 2 is a diagram for illustrating a logical configuration of the management computer 110 of the embodiment of this invention.

The management computer 110 includes a virtual machine allocation program 111. The virtual machine allocation program 111 is stored in the memory, and is executed by the processor. The virtual machine allocation program 111 includes a resource allocation state collection program 112 and a resource usage state collection program 113 as sub-programs.

The virtual machine allocation program 111 manages the allocation of resources to customers. The resource allocation state collection program 112 collects information on the resources allocated to customers. The resource usage state collection program 113 collects a usage state of the resources allocated to customers.

The management computer 110 includes a customer information table 114, a virtual machine allocation plan table 115, a resource management table 116, and a variable fee program usage group management table 117. Those tables are stored in the virtual volumes 121.

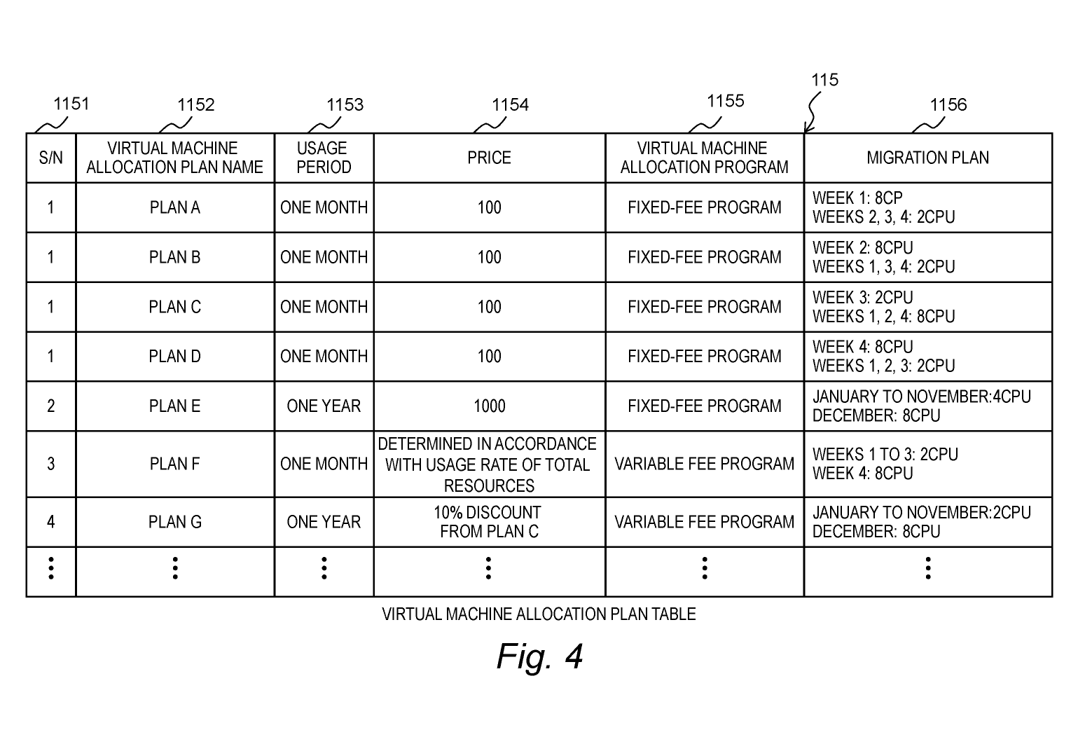

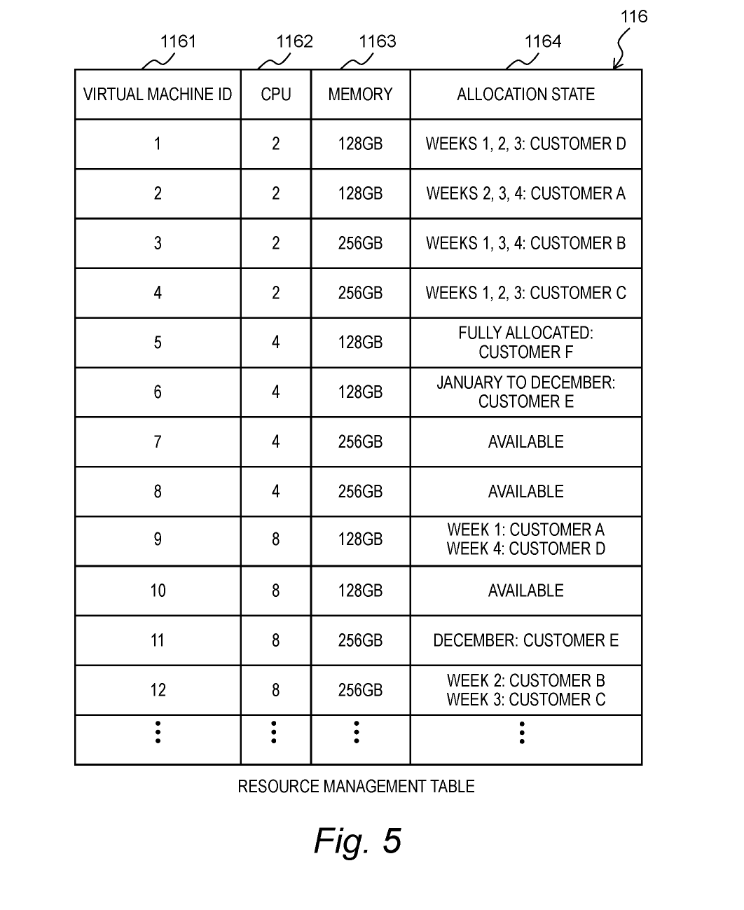

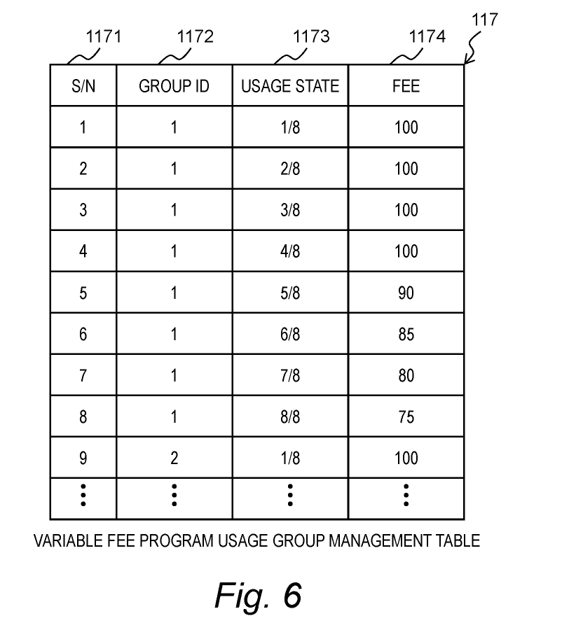

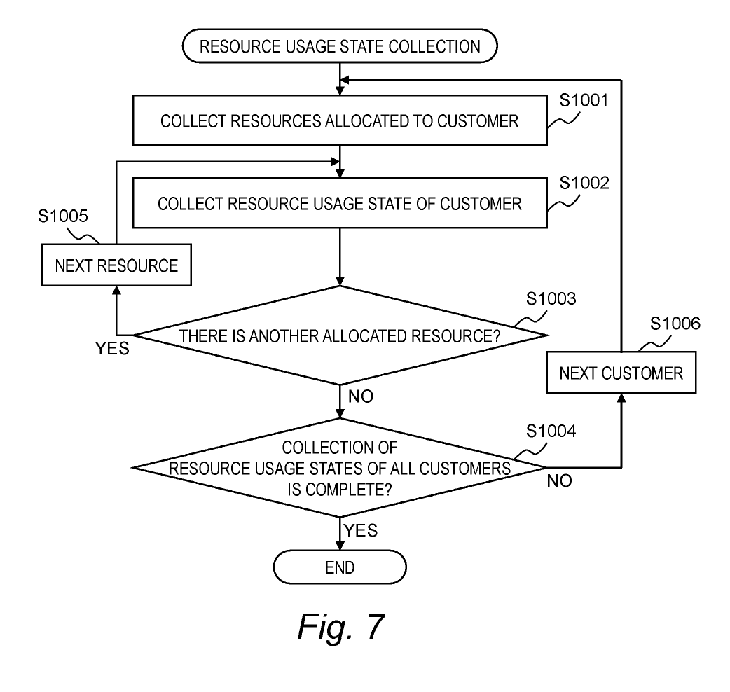

The customer information table 114 is a table for managing the customers receiving a cloud service from the managed service provider. The details of the customer information table 114 are described below with reference to FIG. 3. The virtual machine allocation plan table 115 is a table for managing plans defining the content of the cloud service to be received by each customer. The details of the virtual machine allocation plan table 115 are described later with reference to FIG. 4. The resource management table 116 is a table for managing the resources to be allocated to the virtual machines 131. The details of the virtual machine allocation plan table 115 are described later with reference to FIG. 5. The variable fee program usage group management table 117 is a table for managing a usage rate and a fee of the virtual machines 131. The details of the variable fee program usage group management table 117 are described later with reference to FIG. 6.

FIG. 3 is a diagram for showing a structural example of the customer information table 114 of the embodiment of this invention.

The customer information table 114 is a table for managing the customers receiving a cloud service from the managed service provider. The customer information table 114 includes a serial number 1141, a customer name 1142, a virtual machine allocation plan name 1143, and a virtual machine ID 1144.

The serial number 1141 is identification information for uniquely identifying data stored in the customer information table 114. The customer name 1142 is the name of the customer receiving a cloud service. The virtual machine allocation plan name 1143 is the name of the plan defining the content of the cloud service to be received by that customer. The virtual machine ID 1144 indicates identification information on the virtual machine to be allocated to that customer, and the time period for which the virtual machine is to be allocated.

FIG. 4 is a diagram for showing the virtual machine allocation plan table 115 of the embodiment of this invention.

The virtual machine allocation plan table 115 is a table for managing plans defining the content of the cloud service to be received by each customer. The virtual machine allocation plan table 115 includes a serial number 1151, a virtual machine allocation plan name 1152, a usage period 1153, a price 1154, a virtual machine allocation program 1155, and a migration plan 1156.

The serial number 1151 is identification information for uniquely identifying data stored in the virtual machine allocation plan table 115. The virtual machine allocation plan name 1152 is the name of the plan. The usage period 1153 is the time period for which the customer can use the virtual machine 131 under that plan. The price 1154 is the price of that plan. The price 1154 may be, for example, a fixed fee defined by a number, a usage-based fee that varies based on the usage rate of the resources, or a fee that has been discounted by a predetermined ratio from the fixed fee or usage-based fee.

The virtual machine allocation program 1155 indicates a characteristic of that plan. For example, “fixed-fee program” or “variable fee program” may be recorded in the virtual machine allocation program 1155. The “fixed-fee program” is a plan in which the fee does not vary regardless of the number of users using the virtual machine. For the “variable fee program”, the fee varies based on the number of users using the virtual machine. More specifically, when there are more users using the virtual machine, the fee decreases even when the amount of allocated resources does not change.

The migration plan 1156 indicates a switch of the virtual machine 131 based on migration in that plan. Specifically, the migration plan 1156 indicates the amount of resources that can be used by the customer and the time period for which those resources can be used.

FIG. 5 is a diagram for showing the resource management table 116 of the embodiment of this invention.

The resource management table 116 is a table for managing the resources to be allocated to each virtual machine 131. The resource management table 116 includes a virtual machine number 1161, a processor allocation amount 1162, a memory allocation amount 1163, and an allocation state 1164.

The virtual machine number 1161 is identification information for uniquely identifying each virtual machine 131. The processor allocation amount 1162 is an amount of processor resources to be allocated to that virtual machine (i.e., number of CPUs). The memory allocation amount 1163 is an amount of the memory resources to be allocated to that virtual machine (i.e., amount in a RAM). The allocation state 1164 indicates whether or not that virtual machine is being provided to a customer. In the allocation state 1164, there may be recorded “fully allocated”, which indicates that all time slots have been allocated, “available”, which indicates that none of the time slots have been allocated, or a pair consisting of the time period and the customer to which the virtual machine has been allocated.

FIG. 6 is a diagram for showing the variable fee program usage group management table 117 of the embodiment of this invention.

The variable fee program usage group management table 117 is a table for managing the usage rate and the fee of each virtual machine 131. The variable fee program usage group management table 117 includes a serial number 1171, a group ID 1172, a usage state 1173, and a fee 1174.

The serial number 1171 is identification information for uniquely identifying data stored in the variable fee program usage group management table 117. The group ID 1172 is identification information for uniquely identifying a group using a variable fee program. The group may include one physical computer 130 or a plurality of physical computers 130. The usage state 1173 is a value obtained by dividing the number of customer using that computer by the maximum number of customers. The fee 1174 is the fee per customer of that computer.

As can be seen from the variable fee program usage group management table 117, for the group ID=1, the fee 1174 is set such that the fee becomes lower when the number of virtual computers being used by one physical computer 130 increases. The fee may also be set to be a fixed fee regardless of the number of virtual computers being used by one physical computer 130.

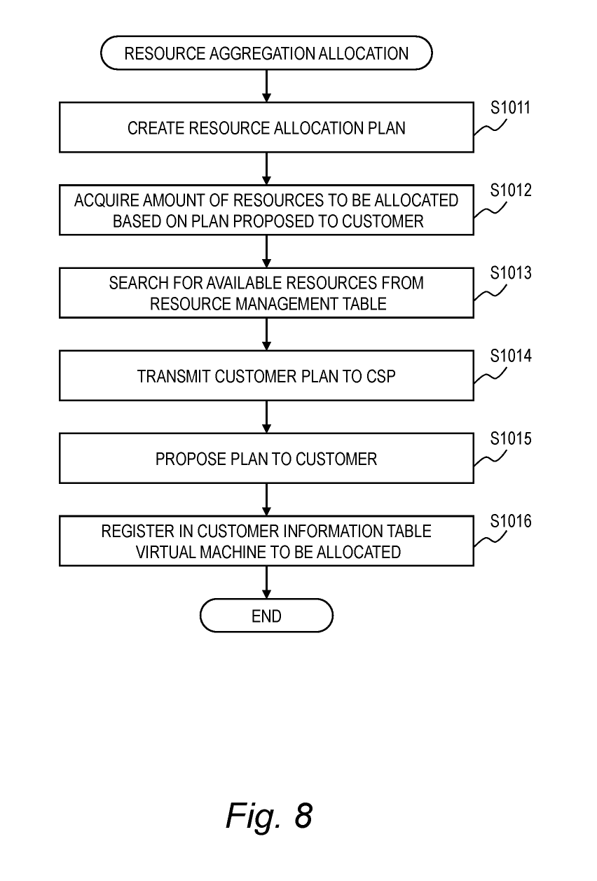

FIG. 7 is a flowchart of resource usage state collection processing of the embodiment of this invention.

The resource usage state collection processing is executed by the management computer 110, and investigates whether or not resources can be aggregated.

First, the virtual machine allocation program 111 selects one customer. The resource allocation state collection program 112 refers to the customer information table 114 and the resource management table 116, and collects information on the resources allocated to the selected customer (Step S1001). For example, a virtual machine 2 (two CPUs and 128 GB memory) and a virtual machine 9 (eight CPUs and 128 GB memory) are allocated to a customer A.

Then, the resource usage state collection program 113 selects one resource allocated to the customer from a baseboard management controller (BMC) implemented in the physical computer 130, and collects the usage state for each predetermined time period (e.g., weekly or monthly CPU usage) of the selected resource (Step S1002).

Then, the virtual machine allocation program 111 judges whether or not there is an allocated resource for which the usage state has not been collected for the selected customer (Step S1003). When In a case where it is judged that there is a resource for which the usage state has not been collected among the resources allocated to the selected customer, the usage state of the next resource is collected (Steps S1005 and S1002). For example, in a case where three virtual machines are allocated, the usage states of the resources of the allocated three virtual machines are collected in order.

On the other hand, in a case where it is judged that collection of the usage states of all of the resources allocated to the selected customer is complete, the virtual machine allocation program 111 judges whether or not collection of the resource usage states of all of the customers is complete (Step S1004). In a case where it is judged that there is a customer for which a resource usage state has not been collected, the usage state of the next customer is collected (Steps S1006 and S1001).

On the other hand, in a case where it is judged that that collection of the resource usage states of all of the customers is complete, the resource usage state collection processing is ended.

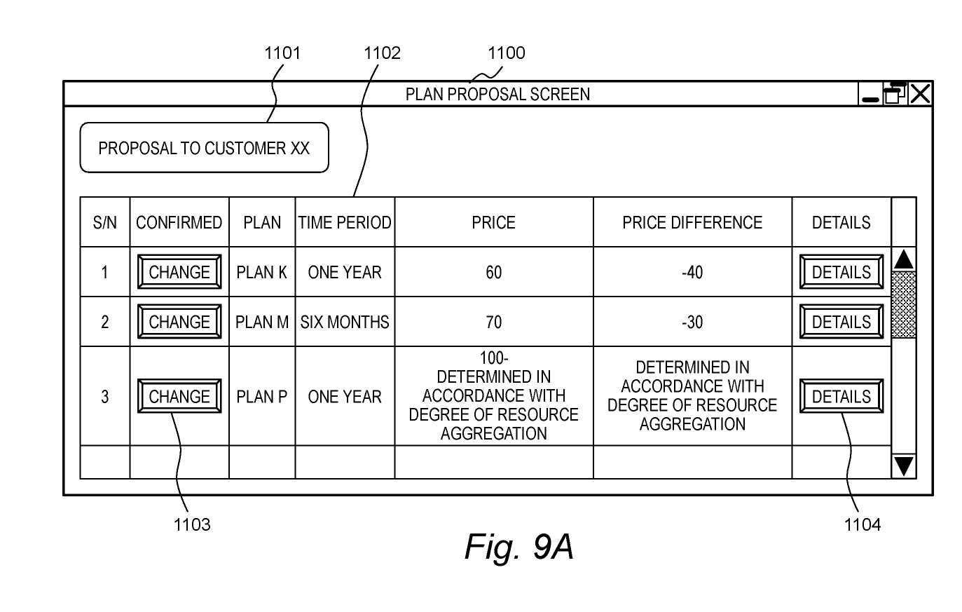

FIG. 8 is a flowchart of resource aggregation allocation processing of the embodiment of this invention.

The resource aggregation allocation processing is executed by the management computer 110. In the resource aggregation allocation processing, a change in plan is proposed to the customers, and resources are aggregated and allocated.

First, the virtual machine allocation program 111 creates, based on the resource usage states of all of the customers, plans in which the resources for each customer have been aggregated (Step S1011).

Next, the amount of resources to be allocated under the created plans (e.g., number of required CPUs) is acquired (Step S1012), and available resources to be allocated to each customer are searched for from the resource management table 116 (Step S1013).

Then, the virtual machine allocation program 111 transmits the created plans for each customer to the cloud service provider terminal 200 (Step S1014).

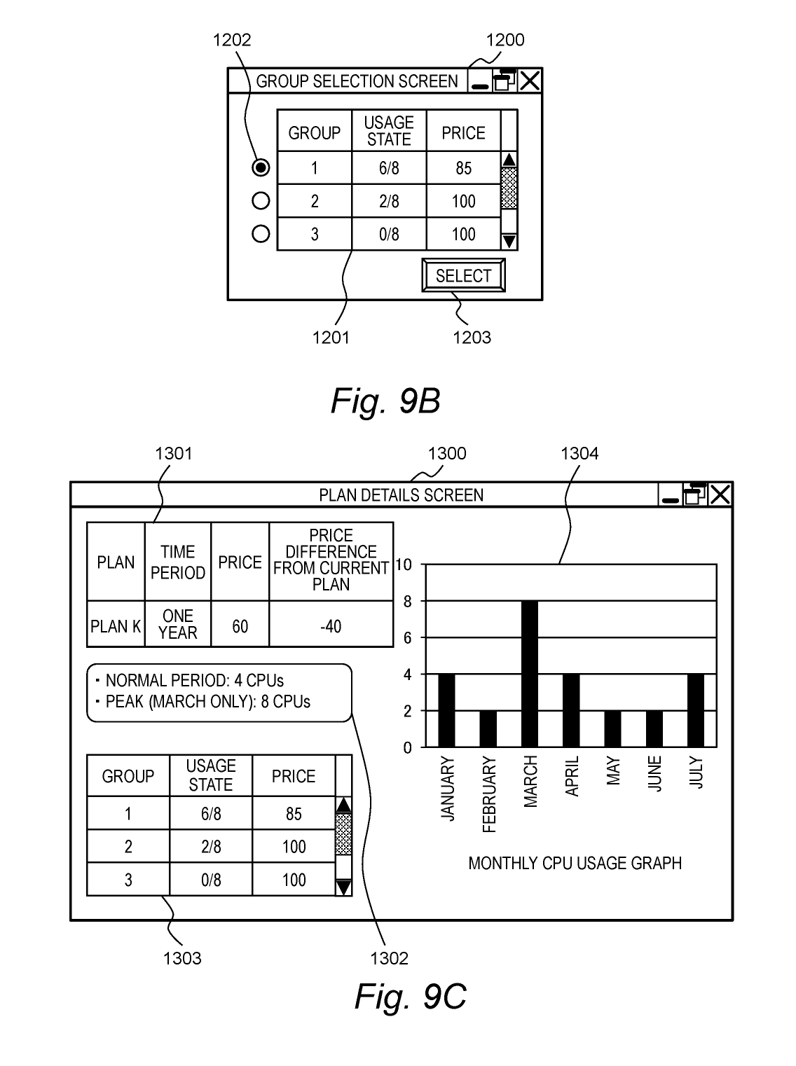

A person in charge for the cloud service provider operates the cloud service provider terminal 200, and transmits to the virtual machine allocation program 111 an instruction to transmit the created plans to each customer. The virtual machine allocation program 111 transmits the created plans to each customer, and proposes the plans (Step S1015). The customer can confirm the proposed plans by using a plan proposal screen 1100 illustrated in FIG. 9A and a plan details screen 1300 illustrated in FIG. 9C. For example, an address (URL) for displaying each plan is transmitted to the customer, and the customer can confirm the proposed plans by accessing those URLs using a web browser. The plans can also be proposed by using a management screen for each customer.

FIG. 9A is a diagram for illustrating a configuration example of the plan proposal screen 1100 to the customers of the embodiment of this invention.

The plan proposal screen 1100 displays a customer name 1101 to which the plan is proposed and a list 1102 of the plans proposed to that customer. The plan list 1102 includes information on the plan name, a contract period of that plan, a price of that plan, and a price difference from the current contracted plan. The customer can display the plan details screen 1300 illustrated in FIG. 9C to see the details of the proposed plan by operating a “details” button 1103. The customer can also select the proposed plan and initiate contract procedures by operating a “change” button 1104.

FIG. 9B is a diagram for illustrating a configuration example of a group selection screen 1200 of the embodiment of this invention.

The group selection screen 1200 is displayed after the “change” button 1104 is operated on the plan proposal screen 1100. On the group selection screen 1200, the customer selects a group (physical computer) providing resources to the virtual machines of the new plan.

The group selection screen 1200 displays a usage state 1201 of the selectable groups, a radio button 1202 to be selected by the customer, and a “select” button 1203.

On the group selection screen 1200, the customer selects a group (physical computer) by selecting a group with the radio button 1202 and operating the “select” button 1203.

FIG. 9C is a diagram for illustrating a configuration example of the plan details screen 1300 for the customers of the embodiment of this invention. The plan details screen 1300 is displayed in a separate window when the “details” button 1104 is operated on the plan proposal screen 1100.

The plan details screen 1300 displays an outline 1301 of the proposed plan, a characteristic 1302 of that plan, a usage state 1303 of the groups that can be selected under that plan, and a usage rate graph 1304. The usage rate graph 1304 displays the monthly CPU usage rate. However, the usage rate graph 1304 can also display the usage rate of other resources for other time periods. On the plan details screen 1300, a time period switch button and a resource switch button can be provided so that the usage rate can be displayed by switching the time period or the resource.

Returning to FIG. 8, after operation of the “change” button 1103 on the plan proposal screen 1100, when operation of the “select” button 1203 on the group selection screen 1200 is detected, the virtual machine ID to be allocated to the new plan selected by the customer and the time period (migration plan) to be allocated to that virtual machine are recorded in the customer information table 114 (Step S1016). The information recorded in the customer information table 114 is also recorded in the virtual machine allocation plan table 115 at a predetermined timing (e.g., every night).

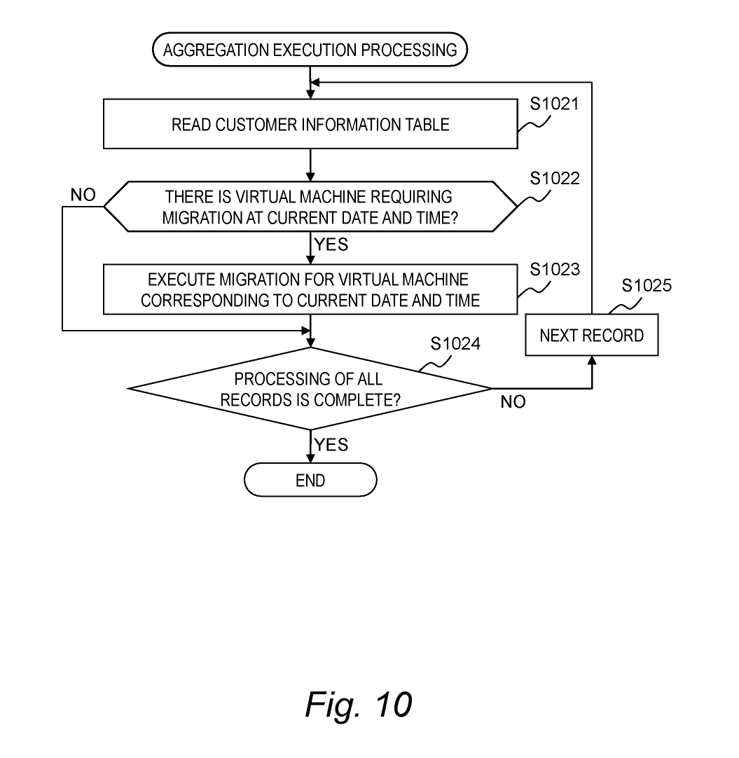

FIG. 10 is a flowchart of aggregation execution processing of the embodiment of this invention.

The aggregation execution processing is executed by the virtual machine allocation program 111 of the management computer 110 at a predetermined timing (e.g., batch processing performed at night, for example, every Sunday at 12 a.m. (midnight)), and reallocation of the resources is executed in accordance with the customer plan.

First, the virtual machine allocation program 111 reads an initial record from the customer information table 114 (Step S1021), refers to the virtual machine ID 1144, and judges whether or not there is a virtual machine requiring migration at the current date and time (Step S1022).

In a case where there are no virtual machines requiring migration at the current date and time, the processing advances to Step S1024. On the other hand, in a case where there is a virtual machine requiring migration at the current date and time, migration is executed for the virtual machine corresponding to the current date and time (Step S1023), and the processing then advances to Step S1024.

In Step S1024, the virtual machine allocation program 111 judges whether or not processing of all of the records in the virtual machine allocation plan table 115 is complete (Step S1024). In a case where processing of all of the records in the virtual machine allocation plan table 115 is complete, the aggregation execution processing is ended. On the other hand, in a case where processing of a part of the records in the virtual machine allocation plan table 115 is not complete, the next record is processed (Steps S1025 and S1021).

As described above, in the embodiment of this invention, the management computer 110 managing the resources to be allocated to the virtual machines 131 to be used by the customers monitors the usage state of the resources allocated to the virtual machines 131, and based on a monitoring result of the resources allocated to the virtual machines 131, creates new allocation plans that reduce the amount of resources to be allocated to the virtual machines 131. Then, based on the selection of an allocation plan by the customer, a migration plan for the virtual machines 131 that includes the virtual machines 131 in the new plan is created. As a result, the virtual machines 131 can be allocated without providing new resources. Further, the virtual machines 131 can be allocated by facilitating other customers accepting a change in resources in order to create available resources.

The allocation plans include at least a fixed plan, in which the fee does not vary based on the usage state of the virtual machines 131 to which the resources of one physical computer are to be allocated, and a variable plan, in which the fee varies based on the usage state of the virtual machines 131 to which the resources of one physical computer are to be allocated, and hence various choices can be provided to the customer. In particular, in a variable plan, the fee for the customer increases in a case where the usage state decreases, and hence the risk of an increased fee can be reduced by selecting a fixed plan.

The virtual computers are grouped by the physical computer providing the resources. In a case where there are a large number of virtual machines 131 being used in one group, the variable plan is determined so that the fee becomes lower. The management computer 110 searches for a group including a physical computer having available resources capable of being allocated to the virtual machines 131 based on the new allocation plan, and calculates the fee for the variable plan based on the number of virtual machines 131 being used in one group, and hence various choices can be provided to the customer. Further, various needs of the customers can be met by increasing the types of plans. For example, resources are excessively divided in a case where many customers are concentrated in a variable plan for a given physical computer, and hence there may be some customers who wish to use a variable plan, but the necessary resources cannot be secured. Meanwhile, there may also be some customers who are satisfied with their current low price. Therefore, a cloud service can be provided at a fee suitable for each customer by grouping the computers and allowing the customer to select the computer group.

The physical computer 130 and the management computer 110 providing resources to the virtual machines 131 are managed by the managed service provider. The virtual machines 131 are provided to each customer by the cloud service provider. The processing by the management computer 110 is executed based on instructions from the managed service provider. Therefore, better allocation plans can be provided. More specifically, the managed service provider can accumulate the know-how for drawing up plans that are acceptable to the customers, and based on those acceptable allocation plans, the cloud service provider can operate an environment having a high cost-performance.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A method of managing a computer system,
the computer system being configured to provide a virtual computer used by a customer,
the virtual computer being coupled to a management computer configured to manage resources to be allocated to the virtual computer,
the method including steps of:
monitoring, by the management computer, a usage state of the resources allocated to the virtual computer;
creating, by the management computer, a new allocation plan in which an amount of resources allocated to the virtual computer is reduced based on the monitored usage state of the resources allocated to the virtual computer; and
creating, by the management computer, a virtual computer migration plan including the virtual computer created by the new allocation plan based on selection of the allocation plan by the customer.

2. The method according to claim 1, further including a step of creating, by the management computer, as the new allocation plan, at least one of a fixed plan, in which a fee is inhibited from varying based on a usage state of a virtual computer to which resources of the physical computer are to be allocated, and a variable plan, in which the fee varies based on the usage state of the virtual computer to which the resources of the physical computer are to be allocated.

3. The method according to claim 2,
wherein the virtual computers are grouped by a physical computer providing the resources,
wherein the variable plan is determined such that the fee becomes lower as a number of virtual computers being used in one group increases, and
wherein the method further including steps of:
searching, by the management computer, for a group including a physical computer having available resources capable of being allocated to a virtual computer based on the new allocation plan; and
calculating, by the management computer, the fee for the variable plan based on the number of virtual computers being used in one group.

4. The method according to claim 3,
wherein the physical computer providing the resources to the virtual computer and the management computer are managed by a managed service provider,
wherein the virtual computer is provided to the customer by a cloud service provider, and
wherein processing performed by the management computer is to be executed based on an instruction from the managed service provider.

5. A computer system, comprising:
a virtual computer used by a customer; and
a management computer configured to manage resources to be allocated to the virtual computer,
the management computer being configured to:
monitor a usage state of the resources allocated to the virtual computer;
create a new allocation plan in which an amount of resources allocated to the virtual computer is reduced based on the monitored usage state of the resources allocated to the virtual computer; and
create a virtual computer migration plan including the virtual computer created by the new allocation plan based on selection of the allocation plan by the customer.

6. The computer system according to claim 5, wherein the management computer is configured to create, as the new allocation plan, at least one of a fixed plan, in which a fee is inhibited from varying based on a usage state of a virtual computer to which resources of one physical computer are to be allocated, and a variable plan, in which the fee varies based on the usage state of the virtual computer to which the resources of one physical computer are to be allocated.

7. The computer system according to claim 6,
wherein the virtual computers are grouped by a physical computer providing the resources,
wherein the variable plan is determined such that the fee becomes lower as a number of virtual computers being used in one group increases, and
wherein the management computer is configured to:
search for a group including a physical computer having available resources capable of being allocated to a virtual computer based on the new allocation plan; and
calculate the fee for the variable plan based on the number of virtual computers being used in one group.

8. The computer system according to claim 7,
wherein the physical computer providing the resources to the virtual computer and the management computer are managed by a managed service provider,
wherein the virtual computer is provided to the customer by a cloud service provider, and
wherein processing performed by the management computer is to be executed based on an instruction from the managed service provider.
